(19) United States
(12) Patent Application Publication
(10) Pub. No.: US 2009/0121139 A1
(43) Pub. Date: May 14, 2009

(54) MATRIX THERMAL IMAGE SENSOR WITH BOLOMETRIC PIXEL AND METHOD OF REDUCING SPATIAL NOISE

(75) Inventor: Gilles CHAMMING'S, Grenoble (FR)

Correspondence Address: LOWE HAUPTMAN & BERNER, LLP, 1700 DIAGONAL ROAD, SUITE 300, ALEXANDRIA, VA, 22314, US

(73) Assignee: COMMISSARIAT A L'ENERGIE ATOMIQUE, Paris (FR)

(21) Appl. No.: 12/253,507

(22) Filed: Oct. 17, 2008

(30) Foreign Application Priority Data
Oct. 23, 2007 (FR) 07 07418

(51) Int. Cl. G01J 5/02; G01J 5/00

(52) U.S. Cl. 250/340; 250/338.1

(57) ABSTRACT

The invention relates to matrix image sensors of the bolometric type, in which each pixel comprises a bolometric resistor whose value varies according to the thermal flow received by the pixel. The resistor is biased by a bias voltage of value Vpol. The current that passes through it is compensated for by a compensation current Icomp, the difference between these currents being integrated in order to produce a measurement signal. The bias voltage (or the compensation current) is adjusted pixel by pixel, for example during a calibration phase, so that all the pixels have an apparent identical sensitivity despite the dispersion of the nominal value of the bolometric resistor. The adjustment is carried out in an analogue manner by storing an individual voltage specific to each pixel in a sensitivity trimmer capacitor specific to this pixel. The capacitor acts directly on the adjustment of the bias voltage or on other parameters playing a role in the sensitivity of the pixel (integration time for example). The spatial noise is thereby considerably reduced.

### RELATED APPLICATIONS

The present application is based on, and claims priority from, French Application Number 07 07418, filed Oct. 23, 2007, the disclosure of which is hereby incorporated by reference herein in its entirety.

### FIELD OF THE INVENTION

The invention relates to matrix thermal image sensors of the bolometric type, in which each pixel comprises a bolometric resistor whose value varies according to the thermal flow received by the pixel.

The pixels are organized in lines and columns and the matrix can be addressed line by line. A signal read circuit is associated with each column of pixels and there are as many read circuits as there are columns. The signals read on each column during the addressing of a line correspond to the reading of the pixels of this line; they are stored and are then extracted from the matrix by a multiplexer while the reading of the subsequent line begins.

### BACKGROUND OF THE INVENTION

During the addressing of a line, a bias voltage is applied to the bolometric resistor, but the value of the bolometric resistor varies according to its temperature; the temperature depends on the bias voltage on the one hand, and on the thermal flow received by the pixel on the other hand; the result of this is that the current passing through the resistor has a common mode component and a component that depends on the thermal flow received by the pixel.

A compensation current is usually subtracted from the current passing through the bolometric resistor in order to reduce or eliminate the common mode component from the current. The compensation current is for example equal to the current passing through the bolometric resistor when it receives an average thermal flow; in this manner, the differential current resulting from the subtraction varies positively or negatively depending on whether the thermal flow varies above or below the average thermal flow. The average thermal flow may for example be the flow that would be received by the pixel from a black body at ambient temperature.

The residual current originating from the subtraction is transmitted to a read circuit associated with the column in which the pixel is situated, and this current is integrated into an integration capacitor forming part of the read circuit; this integration produces an electric voltage representing the thermal flow received by the pixel during the period of integration. The period of integration is slightly less than the period of addressing the line in question. Typically, if the addressing period lasts 64 microseconds, the period of integration may be 50 microseconds.

At the end of the integration period that is common to all the pixels of the line that is addressed, the value of the output signal of the read circuit is stored, for example by pouring the charges or a fraction of the charges of the integration capacitor into a storage capacitor associated with the read circuit of the column in question.

While the process of addressing the subsequent line occurs, all of the stored signals are extracted from the storage capacitors, for example with the aid of an analogue multiplexer which successively supplies on an output bus of the matrix all the signals that have been stored on the storage capacitors and that correspond to the pixels of the line that has just been read. It is also possible to envisage that the read circuit comprises an analogue-digital converter to convert the voltage read into digital. In this case, the multiplexer is naturally digital.

A critical problem encountered with bolometric pixel matrices is the great technological dispersion of the values of the resistors, which induces a great dispersion of the responses in the presence of a uniform thermal illumination. On one and the same matrix there will be encountered, for example, resistors which, at 300 K, will have values from 450 kilohms to 550 kilohms for a theoretical nominal value of 500 kilohms at this temperature, that is a dispersion of approximately 10%.

Because the variation of resistance in the effective range of thermal illumination is barely a few kilohms, it can be conceived that this dispersion of several tens of kilohms at the beginning can be extremely inconvenient; specifically, the signals extracted from the matrix will then represent more the technological dispersion of manufacture of the bolometric resistors than the thermal image that it is desired to detect. The image is therefore drowned in a very great fixed spatial noise which makes it unreadable.

It is for this reason that, in the prior art, it has been proposed
to digitally determine the fixed spatial noise during a calibration phase,
then, outside the calibration phase, to subtract this noise from the payload signals.

The processing of the signals is digital. During the calibration phase, the response of each pixel is determined as a digital value in the presence of a uniform thermal illumination. The difference between the response of a pixel and a desired theoretical response (which could be the average of the responses of all the pixels) is, subsequently, systematically subtracted from the response of the pixel. This is an individual additive correction of the digitized signals originating from each pixel.

If it is desired to enhance the suppression of the spatial noise, a multiplicative correction is also made: all the pixels are illuminated by a second uniform thermal illumination, different from the first. For each pixel, a general slope of variation of response is deduced (already corrected in level by the additive correction) depending on the thermal flow. And then the signal originating from each pixel is corrected so that the slope of variation of the doubly corrected signal (additively and multiplicatively) is the same for all the pixels.

This double correction is however cumbersome to apply and, in practice, in the published prior art, it is applied by a computer which receives the images from the sensor and which completely reprocesses them in order to eliminate the spatial noise therefrom; the cost in computing power is considerable.

### SUMMARY OF THE INVENTION

The proposal according to the invention is to modify the matrix sensor in a manner which makes it possible to reduce or even eliminate the spatial noise before the extraction of the signals from the matrix so that it is not necessary to digitally reprocess the signals originating from the thermal imager.

For this, the invention proposes a matrix thermal image sensor comprising a matrix of lines and columns of pixels, that can be addressed line by line, and a row of signal read circuits each associated with a column of pixels in order to receive successively, as the lines are addressed, a current originating from a pixel of the column, each pixel of the matrix comprising a bolometric resistor whose value Rb depends on the thermal flow received by the pixel, this resistor being biased by a bias voltage of value Vpol, the read circuit comprising an integrating circuit in order to integrate into an integration capacitor the difference between the current Vpol/Rb travelling through the bolometric resistor, and a compensation current, the sensor being characterized in that it comprises, for each column of the matrix, a feedback loop starting from the integration capacitor of the read circuit common to the pixels of the column and ending at a trimmer capacitor specific to each pixel and located in the pixel, in order to store in this trimmer capacitor a trimmer voltage specific to the pixel, and an analogue sensitivity trimmer circuit located in the pixel acting in response to this trimmer voltage in order to modify, when the line to which the pixel belongs is read, the bias voltage of the bolometric resistor, the feedback loop comprising a storage capacitor for storing the analogue voltage VS supplied by the read circuit, a reference capacitor common to the pixels of the column in question, means for precharging this reference capacitor at a determined voltage value, means for adding to this reference capacitor a charge representative of the difference between this determined voltage and the analogue voltage supplied by the read circuit, and means for adding a corresponding charge to the trimmer capacitor so as to increase or decrease the voltage at the terminals of the trimmer capacitor depending on the analogue voltage at the terminals of the reference capacitor.

The trimmer capacitor will therefore receive a trimmer voltage which is specific for each pixel, and it will retain it during the use of the sensor until a new value is applied thereto.

The invention also relates to a method of reducing fixed spatial noise in a matrix thermal image sensor, in which the sensor comprises a matrix of lines and columns of pixels, that can be addressed line by line, and a row of signal read circuits each associated with a column of pixels in order to receive successively, as the lines are addressed, a current originating from a pixel of the column, each pixel of the matrix comprising a bolometric resistor whose value Rb depends on the thermal flow received by the pixel, this resistor being biased by a bias voltage of value Vpol, the read circuit comprising an integrator in order to integrate into an integration capacitor of value Cint, the difference between the current Vpol/Rb travelling through the bolometric resistor and a compensation current, the method being characterized in that
the analogue voltage VS originating from a pixel is measured,
a quantity of charges signed depending on the level of the measured voltage is added to a trimmer capacitor specific to the pixel and located in the pixel,
based on the voltage stored on the trimmer capacitor, a command is given to a trimmer circuit located in the pixel and acting, when the line to which the pixel belongs is read, on the bias voltage Vpol.

The trimmer voltage may be generated during a calibration phase during which the matrix receives a uniform thermal illumination, and during which voltages are established on the trimmer capacitors so that all the pixels supply one and the same output signal for this uniform illumination value. Therefore, the trimmer capacitor will retain, for each pixel, the level of sensitivity correction that is appropriate for this pixel. This calibration phase may be carried out once and for all or periodically. After the calibration phase using a fixed image at uniform temperature, it is possible to freeze the adjustment value determined for each pixel, but it is also possible, as will be seen, to authorize a change depending on the images received in normal use. In the first case, means are provided for authorizing the operation of the feedback loop (that is to say the action on the charge of the trimmer capacitor) during a calibration phase and for preventing it during a phase of use following a calibration phase. In the second case, the feedback loop operates all the time.

If a calibration phase is used with a thermal source supplying a uniform illuminance of all the pixels, it is preferably possible to proceed by a progressive method with a time constant of a few seconds (several tens of images). In this case, the analogue voltage VS is measured cyclically during the calibration phase and the quantity of charges added to the trimmer capacitor is a small quantity of charges such that the trimmer circuit modifies, by a small percentage, preferably less than 10%, the voltage difference VS−Vgris supplied by the pixel for a given illuminance, Vgris being a reference voltage value corresponding to the analogue voltage supplied by a pixel having the desired sensitivity for all the pixels for the average illuminance of the thermal source used for the calibration.

It is also possible not to use a calibration phase and to use only a slaving of the trimmer voltage, with a long time constant such that the trimmer voltage tends progressively to align the sensitivity of the pixel in an average value which, for statistical reasons, will be the same for all the pixels after a large number of images.

“Long time constant” means a read period of at least a hundred successive images, preferably several hundreds of successive images.

In this case, the analogue voltage VS is measured during the normal use of the sensor and the quantity of charges added to the trimmer capacitor is a small quantity of charges such that the trimmer circuit modifies by a still smaller percentage, preferably less than 1%, the voltage difference VS−Vgris supplied by the pixel for a given illuminance, Vgris being a reference voltage value corresponding to the analogue voltage supplied by a pixel having the desired sensitivity for all the pixels for an average illuminance.

Finally, it is possible to use both a calibration phase with a short time constant, with a uniform screen, in order to rapidly approach a state in which all the pixels have the same sensitivity, then a slaving with a long time constant which uses the successive images received by the sensor in normal use in order to continue to adjust the trimmer voltage of each pixel in a direction tending to align the sensitivity of the pixel on an average value common to all the pixels.

Preferably, the value adjusted by the sensitivity trimmer circuit is the value Vpol, that is to say the analogue bias voltage applied to the bolometric resistor during the addressing of the line; the sensitivity trimmer circuit is then specific to the pixel, and the trimmer capacitor, like the sensitivity trimmer circuit, is located geographically in the pixel itself.

The sensitivity trimmer circuit preferably comprises a transistor mounted as a voltage follower, whose source is connected to the bolometric resistor and whose grid is connected to the trimmer capacitor.

The bolometric resistor is preferably connected between the source of the transistor and a fixed potential common to all the pixels of the matrix. The drain of the transistor is connected, via a line address switch, to a column conductor to which the compensation current (Icomp) is applied.

In practice, it is possible to provide the following arrangements: the analogue voltage VS supplied by the read circuit is stored in a storage capacitor and the feedback loop comprises a reference capacitor common to the pixels of the column in question, means for precharging this capacitor to a determined voltage value, means for adding to this reference capacitor a charge representative of the difference between this determined voltage and the analogue voltage VS supplied by the read circuit, and means for adding a corresponding charge in the trimmer capacitor so as to increase or decrease the voltage at the terminals of the trimmer capacitor depending on the analogue voltage of the read circuit.

This storage capacitor which serves in the feedback loop may be the same as that which is situated at the output of the current integrating circuit and which is used to retain an item of signal information VS after the reading of a line and during the addressing of a subsequent line. But it may also be an auxiliary capacitor of smaller value, which receives the same item of output information VS from the integrating circuit.

It is preferred that the sensitivity trimmer capacitor and the corresponding trimmer circuit are placed in the pixel itself, but it is also possible to envisage embodiments in which the trimmer capacitors are placed outside the matrix of pixels and organized in a matrix themselves (a trimmer capacitor of the capacitor matrix corresponding to a respective pixel of the matrix of pixels). Addressing means are then provided in order to address a line of trimmer capacitors in correspondence with the addressing of a line of pixels, during the use of the sensor.

Preferably, the feedback circuit comprises means for incrementing, in the phase of use, the voltage of the trimmer capacitor by a small fraction (typically less than 1%) of the difference between the analogue output voltage VS of the read circuit and a reference voltage (Vgris) defining a desired sensitivity of the pixel for an average illuminance, so that the voltage of the trimmer capacitor stabilizes slowly around an average value; this average value is such that the pixel supplies the reference voltage for an illuminance that is the average of the illuminances received during use. It is statistically identical for all the pixels.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF DRAWINGS

The present invention is illustrated by way of example, and not by limitation, in the figures of the accompanying drawings, wherein elements having the same reference numeral designations represent like elements throughout and wherein:

FIG. 1 represents a general diagram of a bolometric matrix infrared sensor;

FIG. 2 represents the detail of a pixel of the sensor and the signal read circuit at the foot of a column;

FIG. 3 represents the structure of a column with the feedback loop making it possible to adjust the sensitivity of a pixel;

FIG. 4 represents a variant embodiment of FIG. 3.

### DESCRIPTION OF PREFERRED EMBODIMENTS

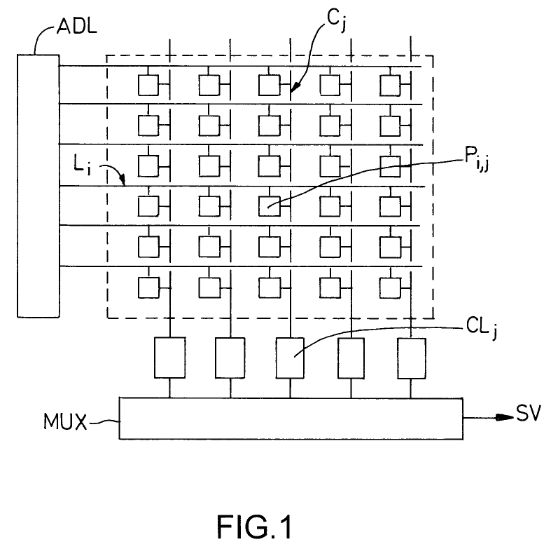

FIG. 1 shows a very schematic view of the matrix sensor designed to produce a signal representing a thermal image taken by an infrared camera whose sensor is the sensitive element.

The sensor comprises a matrix of lines and columns of pixels sensitive to infrared rays. A pixel Pi,j, at the junction of a line of rank i and a column of rank j, is connected to at least one line conductor Li connecting all the pixels of that line and it can be connected to a column conductor Cj connecting all the pixels of that column.

The line conductor Li is used for addressing the line of pixels; a line addressing circuit ADL successively addresses the various lines of the matrix and the addressing of a line of rank i causes the effective connection of each of the pixels of that line to the column conductor corresponding to that pixel. At the foot of each column, there is a read circuit, indicated by CLj for the column of rank j, which can read a signal applied to the corresponding column conductor Cj via the addressed line pixel.

A multiplexer MUX receives the outputs of all the read circuits CLj and makes it possible to rapidly supply to an output SV signals originating from each of the read circuits. For example, the multiplexer MUX transmits to the output SV a succession of signals, each signal corresponding to a respective column, in the order of the columns; this succession is transmitted at a high rate so that all the signals that have been produced at the end of the addressing of a line of the matrix are transmitted to the output SV during the period in which the subsequent line of the matrix is addressed.

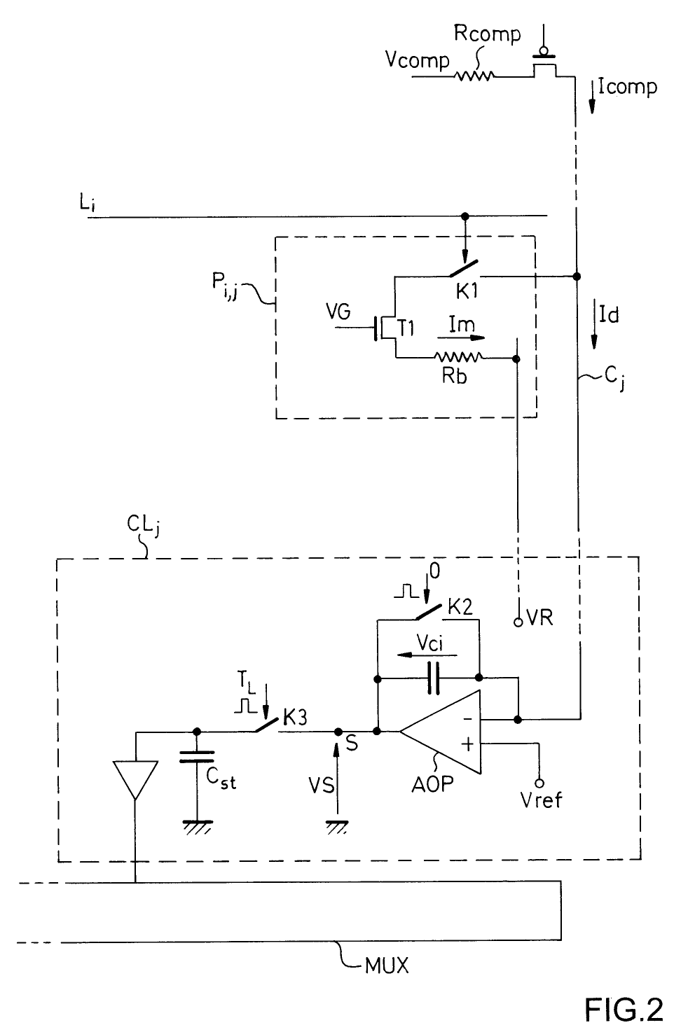

FIG. 2 represents the elementary schematic diagram of an individual pixel Pi,j, whose sensitive element is a bolometric element.

The bolometric element is represented by a resistor Rb whose value varies according to its temperature and whose temperature varies notably according to the integral of the flow of infrared radiation received.

In all that follows, the same name (for example Rb) will be used to indicate the resistive (or capacitive) hardware object or the digital value (resistor or capacitor) of this object.

The bolometric resistor Rb has a first end connected to a reference potential VR (common to all the pixels of the matrix) and a second end connected to the source of a transistor T1 whose grid receives a potential VG. The drain of the transistor T1 is connected, by a switch K1, to the column conductor Cj. The switch K1 is controlled by the line conductor Li; this switch makes or breaks the connection between the pixel Pi,j and the column conductor Cj; the connection is made by closure of the switch K1 when the line Li is addressed; it is broken by opening of the switch K1 when the line is not addressed.

The transistor T1 is conductive during the addressing of the line, because the potential of the column conductor Cj is then greater than the reference potential VR and because the potential VG is chosen to be greater by at least one value VT than the potential VR; VT is the threshold voltage of the transistor T1 and is typically 0.6 volts.

During the addressing of the line Li, the resistance Rb will receive between its terminals a bias voltage Vpol=(VG−VT−VR) and will therefore be crossed by a measurement current Im such that Im=(Vpol/Rb).

This current is drawn from the column conductor Cj to which the resistor is connected by means of the transistor T1 and the switch K1.

Furthermore, a compensation current Icomp is applied to the column conductor Cj at the head of the column, from a power supply source placed at the head of the column. The foot of the column is, as will be seen, kept at a reference potential Vref. If a predetermined voltage Vcomp is applied by means of a fixed-value resistor Rcomp to the column conductor, then the compensation current is Icomp=(Vcomp−Vref)/Rcomp at the head of the column. The current Icomp may be produced by other means than the application of a given voltage to a resistor of given value: in particular, it may be fixed by a current source of known value Icomp.

At the foot of the column, the column conductor Cj is connected to the measurement circuit CLj associated with the column of rank j. This circuit will measure the residual current Id which travels through the column conductor to the foot of the column. This residual current Id is the difference between the current Icomp and the measurement current Im which is drawn by the pixel when it is connected to the column conductor.

The measured residual current is therefore Id=Icomp−Im, or else:

Id=Icomp−Vpol/Rb

The read circuit CLj comprises a current integrating circuit which will integrate the residual current during the period T_{L} reserved for this measurement for a line of pixels. In practice, the line Li is addressed during a period slightly longer than the period T_{L}, before the addressing of the subsequent line, but the integration will take place only during the period T_{L}; for example, the period T_{L} is 50 microseconds for a line addressing period of 64 microseconds. In what follows, if it is a line that is of interest, it will be considered that the beginning of the integration of thermal flow occurs at a moment 0 and the end of the integration occurs at a moment T_{L}.

The current integrating circuit comprises a current integration capacitor of value Cint and it supplies to the terminals of this capacitor a voltage Vci proportional to the integral of the residual current Id:

Vci=1/Cint∫_{(0 at TL)}[Vpol/Rb−Icomp]dt.

As an example, the integrating circuit comprises an operational amplifier AOP whose non-inverting input receives the reference potential Vref and whose inverting input is connected to the column Cj in order to receive the residual current Id therefrom. The capacitor Cint is connected between the inverting input and the output of the operational amplifier AOP. A switch K2 connected between the terminals of the capacitor makes it possible to short circuit the integration capacitor Cint and therefore to zero the voltage at the terminals of this capacitor at a zero-reference moment defining the beginning of a new integration whose period is T_{L}. This switch K2 is therefore briefly closed (for example for four microseconds) at the end of a cycle for addressing the previous line (or at the beginning of the cycle for addressing the line Li) and it opens at the moment 0 defining for each line the beginning of a signal measurement period. By opening, it allows the beginning of integration into the capacitor.

In a conventional manner, because of the presence of the operational amplifier AOP, with large gain and large input impedance, looped via a feedback capacitor, it is possible to say that the potential of the column conductor Cj connected to the inverting input of the operational amplifier remains equal to the potential Vref applied to the non-inverting input. This is why it has been indicated above that the potential of the column conductor Cj is equal to the reference potential Vref.

Therefore, the potential VS present at the output S of the operational amplifier at the end of the integration period is the sum of the potential Vref and the potential Vci:

VS=Vref+Vci, or else

VS=Vref+1/Cint∫_{(0 at TL)}[Vpol/Rb−Icomp]dt

The output S of the amplifier is connected via a switch K3 to a storage capacitor Cst whose function is to store the value of the voltage VS after the end of the integration period and during the reading of the subsequent line. The switch K3 is closed briefly (for example for one microsecond) towards the end of the integration cycle, and then reopened at the moment T_{L} which marks the end of the integration period for a line. The voltage at the terminals of the storage capacitor Cst takes a value equal to the value reached at the moment T_{L} by the voltage VS.

The voltage at the terminals of the storage capacitor Cst is applied, by means of a high-impedance input buffer amplifier (to prevent a loss of charge of the capacitor), to a respective input of rank j of the multiplexer MUX. The multiplexer may transmit a signal corresponding to this voltage at any moment during the time slot reserved for the reading of the pixels originating from the line Li, that is to say during the time slot during which the subsequent line of rank i+1 is addressed.

Therefore, in this bolometric matrix sensor architecture, the measurement signal that will be transmitted by the multiplexer is proportional to the following quantity VS:

VS=Vref+1/Cint∫_{(0 at TL)}[Vpol/Rb−Icomp]dt

or

VS=Vref+1/Cint∫_{(0 at TL)}[(VG−VT−VR)/Rb−Icomp]dt

The compensation current Icomp is preferably chosen, by acting on Vcomp and Rcomp, so that the residual current Id is zero at a reference temperature. This reference temperature is for example an ambient temperature of 300 K. Therefore, at ambient temperature and for an ideal pixel that has a desired nominal resistance Rb0 at 300 K, the parameters VG, VR and Icomp are chosen such that (VG−VT−VR)/Rb0=Icomp. VT is fixed by the technology. VG and VR, and Icomp may be chosen freely. Therefore, this ideal pixel will supply a signal at voltage VS centred around Vref: higher than Vref when it is exposed to a temperature higher than 300 K and lower than Vref when it is exposed to a lower temperature.

But, as has been said above, Rb is a high technological dispersion quantity, and may have, at the reference temperature, values very different from the nominal value Rb0 for the various pixels of the matrix.

The sensor architecture being discussed here is an architecture with line-by-line addressing: the pixel is powered by a bias current only while the line is addressed (typically less than 64 microseconds). This is why a relatively strong bias current is provided in the resistor Rb at that time. The influence of this current is then considerable relative to the variations of this current generated by the exposure of the pixel to infrared radiation. For example, the nominal value of the resistor varies by 15% because of the technological dispersions, whereas the resistor varies only by 1% depending on the illuminance received, between a minimal illuminance and a maximal illuminance. Obtaining on the sensor an image having a real meaning relative to the illuminance received is therefore extremely disrupted by this dispersion.

The invention proposes to individually correct each pixel with the aid of an analogue sensitivity trimmer circuit specific to this pixel, this trimmer circuit reacting to a trimmer voltage value stored in a trimmer capacitor. This voltage value is supplied by a feedback circuit receiving an item of information from the measurement circuit at the foot of a column and supplying a charge to the trimmer capacitor specific to the pixel; the adjustment value may be supplied notably (but not mandatorily) during a calibration phase consisting in a uniform illuminance of the matrix of the sensor (preferably an illuminance at the reference temperature, for example 300 K).

Therefore, a pixel Pi,j having a resistance Rbij0 at the reference temperature will make it possible to establish, via the feedback loop, a voltage on a trimmer capacitor that is specific thereto (but that is not necessarily situated geographically in the pixel itself). The value of the voltage stored on this capacitor will be such that, for an illuminance by a reference thermal flow (or a temperature), the output of the measurement circuit at the foot of a column has a predetermined value, the same as for all the pixels. The feedback circuit is self-correcting and the voltage on the trimmer capacitor is established progressively so that all the pixels supply, at the end of a certain time, the same measurement signal for the reference thermal flow even though their resistances Rbij0 are different from one another at the temperature generated by this flow.

The invention proposes that the trimmer circuit specific to the pixel acts on one of the following parameters:

VG, Vref, T_{L}, Icomp, preferably VG which defines the bias voltage of the bolometric resistor during the addressing of the line.

The trimmer circuit with the trimmer capacitor which controls it are not necessarily located in the pixel itself, but the embodiments in which the trimmer capacitor is located in the pixel are advantageous relative to those that have a trimmer capacitor situated outside the pixel.

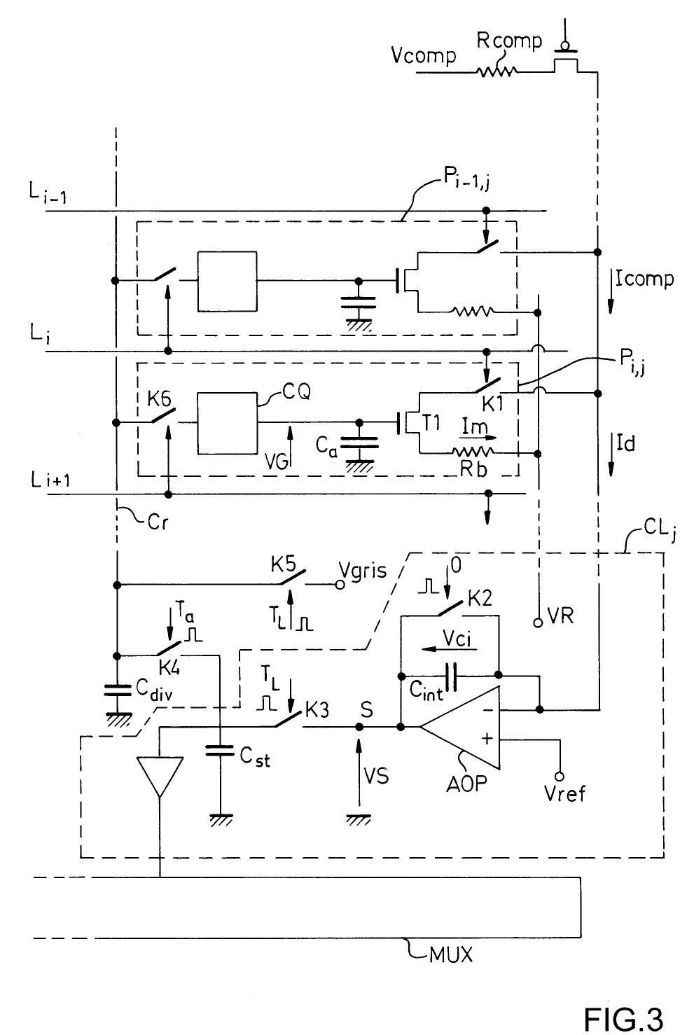

On this subject, an embodiment in which action is taken on the voltage VG in each pixel is particularly advantageous. And it is that embodiment that will now be described with reference to FIG. 3. The overall constitution of the matrix network is the same as in FIGS. 1 and 2, and the particular features added by the invention will be indicated below. The elements that bear the same reference numbers as in FIG. 2 are the same as in FIG. 2.

The trimmer capacitor specific to the pixel and located in the pixel is indicated by Ca. The trimmer circuit consists simply of the transistor T1 already present in FIG. 2; it plays the role of a trimmer circuit because it is mounted as a follower and the voltage on its source follows directly, to within one threshold voltage drop VT, the voltage present on its grid. This grid voltage is now the trimmer voltage present on the trimmer capacitor Ca mounted between the grid of the transistor T1 and a zero potential earth. The grid-substrate capacitor of the transistor T1 may furthermore be considered as being a part of the trimmer capacitor Ca.

The trimmer voltage, or grid voltage VG of the follower transistor, directly determines the bias voltage of the bolometric resistor as has been explained above:

Vpol=VG−VT−VR, VG now being a voltage that can be individually varied for each pixel.

FIG. 3 represents two adjacent pixels Pi,j and Pi−1,j, each comprising a bolometric resistor biased by means of a follower transistor; the bolometric resistor Rb is connected between the source of the follower transistor and a point at the reference potential VR common to all the pixels. The threshold voltage VT of the transistor may be considered identical for all the pixels.

The feedback circuit which is used to establish an appropriate trimmer voltage on the capacitor Ca comprises a charge incrementation circuit CQ whose function is to add to the trimmer capacitor, after the reading of a line, a signed quantity of charges that is larger when the sensitivity of the pixel differs from the nominal sensitivity desired for all the pixels. The quantity of charges is positive or negative and is added to the quantity of charges previously stored on the trimmer capacitor. The sign of the quantity of charges thus added is such that the sensitivity of the pixel tends to move closer to the desired nominal sensitivity.

The incrementation circuit CQ uses as control, in order to determine the quantity of charges to be added or subtracted, the level of voltage VS collected by the read circuit CLj at the end of reading the line, therefore after the moment T_{L} which defines the end of reading. It is specifically this level which represents, for a given illuminance, the sensitivity of the pixel.

However, in order to establish progressively and not instantaneously a level of trimmer voltage on the capacitor Ca, the method preferably proceeds by very small incrementations in the following manner: the voltage level VS that is stored in the storage capacitor Cst at the end of reading the line, is applied to a larger size capacitor Cdiv precharged at an average voltage level that will be explained below and that in this instance will be called Vgris. Vgris is preferably equal to Vref. The precharge is preferably carried out during a brief time slot at the end of the period T_{L} for current integration. During this time slot, a switch K5 connects the capacitor Cdiv to a voltage reference Vgris. The control of the switch K5 is in practice simultaneous with the control of the switch K3.

After the precharge of the capacitor Cdiv, the voltage present at the terminals of the storage capacitor Cst, is applied to this capacitor, a voltage which represents the output voltage VS at the end of reading the pixel. A switch K4 is used to connect the capacitor Cst to the capacitor Cdiv. The switch K4 is closed briefly and this closure can be carried out only after the re-opening of the switch K5.

The role of the capacitor Cdiv is to constitute a sort of capacitive divider such that the voltage at the terminals of the capacitor Cdiv, initially at Vgris because of the precharge, increments by a fraction of the difference between VS and Vgris. More precisely, the voltage changes from Vgris to

Vgris+(VS−Vgris)·Cst/(Cst+Cdiv)

Therefore, if the voltage VS is equal to Vgris, there is no increase or decrease in the voltage on the precharged capacitor Cdiv. But if the voltage VS is higher or lower than Vgris, the voltage at the terminals of the capacitor Cdiv varies slightly, by a fraction of the difference between VS and Vgris.

The voltage at the terminals of the capacitor Cdiv is then applied as the control voltage to the charge incrementation circuit CQ in order to modify the charge of the trimmer capacitor Ca in proportion to the difference (VS−Vgris)·Cst/(Cst+Cdiv), that is to say in proportion to the small incrementation or decrementation of voltage that has just been made on the capacitor Cdiv. In FIG. 3, the charge incrementation circuit is represented as being located geographically in each pixel. It is also possible to envisage an incrementation circuit common to all the pixels.

The charge variation of the capacitor Ca is naturally made in a direction tending to bring the sensitivity of the pixel to the desired nominal value.

The calibration of sensitivity of the pixel is therefore preferably carried out by measuring the analogue voltage VS permanently and by adding to the trimmer capacitor a small quantity of charges such that the trimmer circuit modifies by a small percentage the voltage difference VS−Vgris supplied by the pixel for a given illuminance, Vgris being a reference voltage value corresponding to the analogue voltage supplied by a pixel with a sensitivity desired for an average illuminance. “Small percentage” must mean a percentage below 10% if the calibration is carried out in a specific calibration phase based on a uniform illuminance source, and a percentage of 1% or less if the calibration is carried out during use itself without uniform illuminance source.

The capacitor Cdiv must be connected to the charge incrementation circuit of the pixel whose voltage VS has just been measured. For this, the capacitor Cdiv may be connected to the pixel by a return conductor Cr which is common to the whole column of pixels (column of rank j).

The incrementation circuit CQ of the pixel Pi,j must make a transfer of charges to the capacitor Ca only while the conductor Cr transports an item of voltage information relative to this pixel and not while it transports an item of information relative to a measurement on another pixel. This is why a switch K6 connects the input of the circuit CQ to the conductor Cr, and this switch is closed only during the period of addressing a line, after which it is open.

Naturally, if it is the pixel Pi,j which gives rise to a voltage (VS−Vgris)·Cst/(Cst+Cdiv) on the conductor Cr, care must be taken that it is the pixel Pi,j and not the previous pixel or the subsequent pixel which receives this voltage at the end of the addressing of the line of rank i.

According to the sequencing of the signals, there are two possible hypotheses:
in a first hypothesis, the addressing of the line Li ends at the time T_{L} which defines the end of integration of the current in the capacitor Cint; the addressing of a new line of rank i+1 begins at this moment; the voltage (VS−Vgris)·Cst/(Cst+Cdiv) is available on the return conductor Cr only after the period T_{L}; in this hypothesis, as shown in FIG. 3, the corresponding switch K6 is closed by the control for addressing the line of rank i+1 and not by the control for addressing the line of rank i; therefore, it is indeed the pixel Pi,j which receives the item of information established from the reading of this same pixel even though the addressing of the subsequent line has already begun;
in a second hypothesis, the time is taken to apply the voltage to the return conductor Cr before moving on to the addressing of the subsequent line, so that the switch K6 can then be controlled by the line conductor Li which corresponds to the pixel Pi,j and not by the conductor of rank i+1; in this second hypothesis, it is preferable to provide an auxiliary storage capacitor C′st to be used to constitute the voltage on the return conductor Cr, the capacitor C′st receiving the same voltage VS as the capacitor Cst.

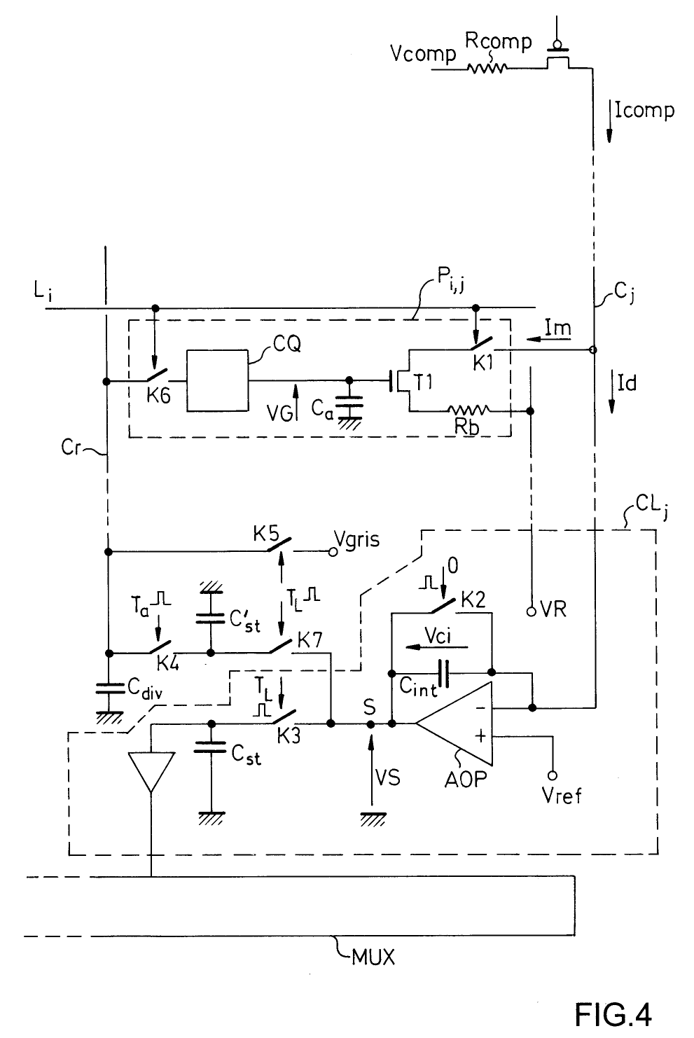

The first hypothesis is used in the diagram of FIG. 3; the second hypothesis is used in the diagram of FIG. 4. In FIG. 4, the elements that are common with those of FIG. 3 are indicated by the same references.

In FIG. 3, the feedback loop therefore comprises, between the output of the current integrating circuit and the trimmer capacitor:
the storage capacitor Cst and the switch K3, which both form part at the same time of the read circuit CLj;
the capacitor Cdiv, the switch K5 which resets the voltage Vgris, the switch K4 which makes it possible to modify its voltage after initialization, the return conductor Cr (one per column) which transmits an item of information to the pixel concerned,
the switch K6 and the charge incrementation circuit CQ, located geographically in the pixel.

In FIG. 4, the connection between the return conductor Cr and the pixel Pi,j is made by a switch K6 which is closed during the addressing of the line Li which corresponds to the pixel Pi,j and not by the addressing of the line Li+1 which corresponds to the pixel Pi+1,j. In addition, while in FIG. 3 the capacitor Cst played a dual role of storing the voltage VS to be sent to the multiplexer and of controlling the voltage level of the capacitor Cdiv, these two roles are now separate, the second role being allocated to the auxiliary capacitor C′st.

The capacitor C′st may be charged at the voltage VS during a brief moment at the end of the period T_{L} thanks to a switch K7 connected between the output of the amplifier AOP and the capacitor C′st. The switch K7 is actuated at the same time as the switch K3 and the switch K5. The switch K4 is no longer connected between the capacitor Cst and the capacitor Cdiv but between the capacitor C′st and the capacitor Cdiv. The capacitor Cst may then have a much higher value than the capacitor C′st. As an example, Cst has a value of 1 picofarad and C′st of 0.1 picofarad in the diagram of FIG. 4, while Cst has instead a value of 0.1 picofarad in the diagram of FIG. 3 in order to be able to fulfil both the main role of storing the level of the pixel in normal use and the auxiliary role of generating the trimmer voltage on the return conductor Cr.

In the diagram of FIG. 4, the feedback circuit used to generate the trimmer voltage VG on the capacitor Ca essentially comprises:
an additional capacitor C′st and the switch K7 which makes it possible to apply thereto the output voltage VS originating from the pixel;
the capacitor Cdiv, the switch K5 that resets it to the voltage Vgris, the switch K4 which makes it possible to modify its voltage after initialization, the return conductor Cr (one per column) which transmits an item of information to the pixel concerned,
the switch K6 and the charge incrementation circuit CQ located in the pixel.

Whether through the diagram of FIG. 3 or the diagram of FIG. 4, it is understood that during a calibration phase which lasts for several tens of images with a uniform illuminance, all the pixels will progressively supply one and the same voltage level VS equal to Vgris, gradually as their trimmer capacitor Ca progressively charges or discharges in order to compensate for the difference noted between VS and Vgris. The smaller the capacitive division ratio is Cst/(Cst+Cdiv) or C′st/(C′st+Cdiv) the longer the time constant for establishing the trimmer voltage.

The voltage Vgris is chosen according to the constitution of the charge incrementation circuit CQ. Specifically, the function of the latter is to convert a voltage (VS−Vgris)·Cst/(Cst+Cdiv) into a quantity of charges dQ proportional to (VS−Vgris). For example, by admitting that this charge incrementation conversion circuit, which makes a voltage/charge conversion, is constituted in a symmetric manner and supplied between a low supply voltage at 0 volt and a high supply voltage at Vdd, it is understood that it will easily be able to carry out a creation of quantity of charges proportional to VS−Vgris if Vgris is chosen to be equal to Vdd/2. If this is the case (but it is not obligatory), Vgris=Vdd/2 will be chosen and the switch K5 will be connected to a voltage Vdd/2 obtained for example by a resistive dividing bridge placed between the potentials 0 and Vdd.

In the description of FIGS. 3 and 4, it can be seen that the sensitivity trimmer of the pixel is carried out by individual trimming of the voltage VG of the transistor for controlling the bolometric resistor, and this trimming amounts to adjusting the bias Vpol applied to the pixel during the reading of the line since Vpol=VG−VT−VR; VT and VR are fixed quantities in these embodiments.

As a variant, it is also possible to provide for the trimmer voltage to be used to control the value of the compensation current Icomp applied to the column conductor during the addressing of the line corresponding to the rank i of the pixel concerned. It is possible for example to provide in the pixel a diversion to the earth of a current controlled by the trimmer voltage obtained by the feedback circuit.

Equally, it is possible to provide for the reference voltage Vref to be modified by the feedback circuit, and this can be done for each pixel. But it is understood that, in this case, the feedback circuit does not return to the pixel since the voltage of Vref is not brought geographically into the pixel. This means that it is necessary to provide, outside the matrix of the sensor itself, a network of trimmer capacitors capable of acting on the reference voltage Vref in the same way that the trimmer capacitor Ca of FIGS. 3 and 4 acts on the voltage Vpol. This network of trimmable capacitors can be addressed at the same time as the lines of pixels in order to be able to have a specific trimmable capacitor correspond to a given pixel, both during a calibration operation and during normal use if these two operations are distinct.

Another possibility consists in acting on the integration period T_{L} so that each pixel has an adjusted integration period so that the apparent sensitivity of the pixel for a reference illuminance is the same for all the pixels. Specifically, the signal level VS depends directly, as has been seen, on the integration period T_{L}. Here again, it is necessary to provide a network of trimmable capacitors outside the pixels, that can be addressed at the same time as the lines of the bolometer matrix, each capacitor making it possible to act on the read circuit CLj to adjust a specific integration time, for each line addressed (and also of course for each column considered during the addressing of that line).

Finally, it should be remembered that a calibration phase with a reference thermal luminance screen is not obligatory and that the calibration may simply consist in letting the trimmer voltage progressively take a stable value corresponding to one and the same average sensitivity value for all the pixels. The recursive method indicated above, by which a small signed charge increment is added to the trimmer capacitor when the pixel supplies a signal different from the average reference Vgris, specifically leads progressively to a stabilization of all the pixels around an average sensitivity when it is considered that, on a large number of images, all the pixels must see one and the same statistical distribution of thermal luminances. If this method of automatic calibration is used, the time constant must be very large (several hundreds of images, that is to say several seconds at least) and consequently the capacitive division ratio Cst/(Cst+Cdiv) or C′st/(C′st+Cdiv) must be very small (preferably less than or equal to 0.01). It is in effect the condition for each new illuminance of a pixel to modify only very slightly the trimmer voltage VG stored on the capacitor Ca.

If a mixed method is adopted, that is to say an initial calibration phase with exposure of the whole matrix to a uniform thermal flow followed by a phase of use with permanent self-correction, it is preferably necessary to provide means for modifying the time constant between the two phases (shorter in calibration, for example a period of 10 to 50 images, longer in use, for example 100 to 500 images); this modification can be made by replacing the capacitor C′st with another capacitor of a different value.

If the calibration method by exposure to a uniform reference thermal flow is the only one used (with a time constant that is preferably fairly short (less than 1 second or a few tens of images), then it is necessary to provide means (not shown in FIGS. 3 and 4) for allowing the operation of the feedback loop in the calibration phase and preventing it thereafter in the phase of use. The trimmer voltage generated during the calibration phase is retained on the capacitor Ca during the phase of use until a new calibration phase.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Matrix thermal image sensor comprising a matrix of lines and columns of pixels, that can be addressed line by line, and a row of signal read circuits each associated with a column of pixels in order to receive successively, as the lines are addressed, a current originating from a pixel of the column, each pixel of the matrix comprising a bolometric resistor whose value Rb depends on the thermal flow received by the pixel, the resistor being biased by a bias voltage of value Vpol, the read circuit comprising an integrating circuit in order to integrate into an integration capacitor the difference between a current Vpol/Rb travelling through the bolometric resistor, and a compensation current, wherein said sensor comprises, for each column of the matrix, a feedback loop starting from the integration capacitor of the read circuit common to the pixels of the column and ending at a trimmer capacitor specific to each pixel and located in the pixel, in order to store in this trimmer capacitor a trimmer voltage specific to the pixel, and an analogue sensitivity trimmer circuit located in the pixel acting in response to this trimmer voltage in order to modify, when the line to which the pixel belongs is read, the bias voltage of the bolometric resistor, the feedback loop comprising a storage capacitor for storing an analogue voltage VS supplied by the read circuit, a reference capacitor common to the pixels of the column in question, means for precharging this reference capacitor at a determined voltage value, means for adding to this reference capacitor a charge representative of the difference between this determined voltage and the analogue voltage VS supplied by the read circuit, and means for adding a corresponding charge to the trimmer capacitor so as to increase or decrease the voltage at the terminals of the trimmer capacitor depending on the analogue voltage at the terminals of the reference capacitor.

2. Matrix thermal image sensor according to claim 1, wherein the sensitivity trimmer circuit comprises a transistor mounted as a voltage follower, whose source is connected to the bolometric resistor and whose grid is connected to the trimmer capacitor.

3. Matrix thermal image sensor according to claim 2, wherein the bolometric resistor is connected between the source of the transistor and a fixed potential common to all the pixels of the matrix.

4. Matrix thermal image sensor according to claim 2, wherein the drain of the transistor is connected, via a line address switch, to a column conductor to which the compensation current is applied.

5. Matrix thermal image sensor according to claim 1, wherein the reference capacitor is situated at the foot of a column and is connected via a return conductor to the pixels of the column.

6. Matrix thermal image sensor according to claim 1, wherein the storage capacitor is a main storage capacitor used to maintain a signal information relative to analogue voltage VS after the reading of a line and before the addressing of a subsequent line.

7. Matrix thermal image sensor according to claim 1, wherein the storage capacitor is an auxiliary capacitor, used to receive a voltage that is identical to that which is applied to a main storage capacitor used to maintain a signal information relative to analogue voltage VS after the reading of a line and during the addressing of a subsequent line.

8. Thermal image sensor according to claim 1, comprising means for allowing the operation of the feedback circuit during a calibration phase and in order to prevent it during a phase of use following a calibration phase.

9. Thermal image sensor according to claim 1, wherein means are provided for incrementing, in the phase of use, the voltage of the trimmer capacitor by a small fraction of the difference between the output voltage of the read circuit and a reference voltage defining a desired sensitivity of the pixel for an average illuminance, so that the voltage of the trimmer capacitor stabilizes slowly to a value such that the pixel supplies the reference voltage for an illuminance which is the average of the illuminances received during use.

10. Method for reducing fixed spatial noise in a matrix thermal image sensor, in which the sensor comprises a matrix of lines and columns of pixels, that can be addressed line by line, and a row of signal read circuits each associated with a column of pixels in order to receive successively, as the lines are addressed, a current originating from a pixel of the column, each pixel of the matrix comprising a bolometric resistor whose value Rb depends on the thermal flow received by the pixel, this resistor being biased by a bias voltage of value Vpol, the read circuit comprising an integrator in order to integrate into an integration capacitor of value Cint, the difference between a current Vpol/Rb travelling through the bolometric resistor and a compensation current, wherein
an analogue voltage VS originating from a pixel is measured at an output of the read circuit,
a quantity of signed charges depending on the level of the measured voltage is added to a trimmer capacitor specific to the pixel and located in the pixel,
based on the voltage stored on the trimmer capacitor, a command is given to a trimmer circuit located in the pixel and acting, when the line to which the pixel belongs is read, on the bias voltage Vpol.

11. Method according to claim 10, wherein the analogue voltage VS is measured during a calibration phase during which the matrix is illuminated by a uniform reference illuminance.

12. Method according to claim 11, wherein the analogue voltage VS is measured cyclically during the calibration phase and the quantity of charges added to the trimmer capacitor is a small quantity of charges such that the trimmer circuit modifies by a percentage less than 10% the voltage difference VS−Vgris supplied by the pixel for a given illuminance, Vgris being a reference voltage value corresponding to the analogue voltage supplied by a pixel of desired sensitivity for the reference illuminance.

13. Method according to claim 10, wherein the analogue voltage VS is measured cyclically during the normal use of the sensor and the quantity of charges added to the trimmer capacitor is a small quantity of charges such that the trimmer circuit modifies by a percentage less than 1% the voltage difference VS−Vgris supplied by the pixel for a given illuminance, Vgris being a reference voltage value corresponding to the analogue voltage supplied by a pixel of desired sensitivity for an average illuminance.

14. Matrix thermal image sensor according to claim 3, wherein the drain of the transistor is connected, via a line address switch, to a column conductor to which the compensation current is applied.

15. Method according to claim 11, wherein the analogue voltage VS is measured cyclically during the normal use of the sensor and the quantity of charges added to the trimmer capacitor is a small quantity of charges such that the trimmer circuit modifies by a percentage less than 1% the voltage difference VS−Vgris supplied by the pixel for a given illuminance, Vgris being a reference voltage value corresponding to the analogue voltage supplied by a pixel of desired sensitivity for an average illuminance.

16. Method according to claim 12, wherein the analogue voltage VS is measured cyclically during the normal use of the sensor and the quantity of charges added to the trimmer capacitor is a small quantity of charges such that the trimmer circuit modifies by a percentage less than 1% the voltage difference VS−Vgris supplied by the pixel for a given illuminance, Vgris being a reference voltage value corresponding to the analogue voltage supplied by a pixel of desired sensitivity for an average illuminance.
